(19) United States
(12) Patent Application Publication
(10) Pub. No.: US 2015/0099641 A1
(43) Pub. Date: Apr. 9, 2015

(54) METHOD FOR MANUFACTURING ELECTRODE OF LITHIUM BATTERY

(71) Applicant: Christine Jill LEE, Hsin-Chu (TW)

(72) Inventors: Christine Jill Lee, Hsin-Chu (TW); Shinn-Dar Wu, Hsin-Chu (TW); Joseph Lee, Hsin-Chu (TW); Jenq-Gong Duh, Hsinchu (TW)

(73) Assignee: Christine Jill LEE, Hsin-Chu (TW)

(21) Appl. No.: 14/249,822

(22) Filed: Apr. 10, 2014

(30) Foreign Application Priority Data
Oct. 8, 2013 (TW) 102136414

(51) Int. Cl. H01M 4/04; H01M 4/1395; H01M 4/1393; C25D 7/06

(52) U.S. Cl. CPC H01M 4/0402; C25D 7/0614; H01M 4/0421; H01M 4/0435; H01M 4/045; H01M 4/1395; H01M 4/1393
USPC 505/470; 205/59; 427/123; 427/124; 427/122; 427/125; 427/62

(57) ABSTRACT

The present invention provides a method for manufacturing an electrode of a lithium battery electrode, comprising: (a) providing a substrate; (b) coating a paste on a portion of the substrate; (c) plating a metal film onto the paste or the substrate; (d) disposing a welding point at an end of the substrate; wherein the advantages of the present invention are to conduct current in three-dimensional direction and reduce the problem of electric conductivity because of thermal effect. In addition, the present invention can further avoid the problem of the electrode oxidation.

### BACKGROUND OF THE INVENTION

1. Field of the Invention

The present invention relates to a method for manufacturing an electrode of a lithium battery, and more particularly to a method for manufacturing the electrode of the lithium battery through covering a conductive metal film on the paste or the electrode plate.

2. Description of Related Art

As technology advances, electronic equipment, weapons system, space exploration and other developments are moving towards a more sophisticated and ultra-functional direction. The system responsible person definitely does not want failure of the expensive equipment because of cheaper battery. Therefore, developing a battery with high energy density per unit volume will become an inevitable trend, while the demand for high discharge current density is one of the goals. Therefore, the research of lithium battery is developed correspondingly.

The lithium battery actually includes a series of battery systems having lithium or lithium alloy a cathode, and there are numerous types. Their main advantages include: (1) high voltage: the open-circuit voltage when it does not flow the current can reach 3.9 V, and the discharge voltage is about 3.0 V, which is 2 times of the traditional battery; (2) high energy density: the metal lithium is light weight, high voltage, and it usually has two to three times energy of the dry battery; (3) wide application temperature range: it does not use aqueous solution, the electrolyte temperature range is very broad. From −40 to 70 degrees Celsius, it can all discharge; (4) high power: the high temperature lithium battery can discharge at ultra-high current density by up to 1 amp per square centimeter; (5) long storage life: due to chemical characteristics and sealing requirements, the life is 5-10 years or longer.

In the electromotive force table, the anode reaction electromotive force for Li+e−→Li is up to 3.0 volts, ranked first. Then, checking the physical and chemical properties of lithium metal, the density is 0.53 g/cubic centimeter, and only a little more than half the water. High voltage and light weight make the energy density of lithium batteries on the inherent large advantage. The actual weight of the battery includes the housing, the electrolyte, the conductive body, and the weight of isolated paper such that the energy density often less than half the theoretical value.

Lithium battery is actually a series of batteries using Lithium as the cathode active material. There are more than 100 kinds of combinations in lab, but only about ten kinds can be practicably applied. Because metal lithium will generate strong reaction when contacting with water, the electrolyte solution is certainly the non-aqueous solution. It generally use organic solvent such as acetonitrile (CH3CN), dimethyl sulfoxide ((CH3)2 SO), or propylene carbonate ((C3H6)CO3), etc. In addition, the metal lithium is soft, it cannot be directly used as a negative electrode plate, and it usually be pressed in the nickel grid as the negative electrode.

In conventional rolling and extruding process for the electrode of the lithium battery, the paste is usually coated directly to the electrode plate. After the rolling and extruding process, the paste is more dense and stretchable. Then, the electrode plate and the paste are packaged. And later, a method for improving the process is invented by Japanese. Firstly, dispose a nickel metal film as a cover layer on the electrode plate. Then, the paste is coated on the nickel metal film, and using rolling press and extend process to increase adhesion; Additionally, this process can reduce the contact resistance, and make the electric conduction between the paste and the nickel metal film be better. However, the electric conduction provided by the above process is only two-dimensional as the conventional process (i.e., one-direction convergence).

### SUMMARY OF THE INVENTION

As a result, the present invention provides a method for manufacturing an electrode of a lithium battery. In this invention, it will use a different manufacturing method to reach different effects not obtained in the conventional method. For example, it can improve one direction convergence of current in the conventional art, reducing the problem of decreasing conductivity because of the thermal effect, solving the problem of decline rate, and enhancing electrical property.

In order to solve the above technical problems, a technical solution provided by the present invention is: a method for manufacturing an electrode of a lithium battery, comprising steps of: (a) providing a substrate; (b) coating a paste on a portion of the substrate; (c) plating a metal film onto the paste or the substrate; and (d) disposing a welding point at an end of the substrate.

Wherein, further including a step for rolling and extruding the paste between the step (b) and the step (c).

Wherein, in the step (c), the metal film is plated onto the paste or the substrate through vapor deposition, electroplating or reduction plating.

Wherein, the substrate includes copper, aluminum, nickel, manganese, cobalt or combinations thereof.

Wherein, the paste includes a lithium compound, an electric conduction agent, an adhesive or combinations thereof.

Wherein, the lithium compound includes cobalt oxide, lithium nickel oxide, lithium manganese oxide, lithium iron phosphate, lithium nickel cobalt oxide, lithium nickel manganese cobalt lithium or combinations thereof.

Wherein, the electric conduction agent includes ordinary carbon black, superconducting carbon black, colloidal graphite or combinations thereof.

Wherein, the adhesive is a PVDF adhesive.

Wherein, the paste includes graphite, an adhesive, an anti-precipitation agent, isopropyl alcohol, water, or combinations thereof.

Wherein, the adhesive is a styrene-butadiene rubber (SBR) adhesive.

Wherein, the anti-precipitation agent is a carboxymethyl cellulose (CMC) anti-precipitation agent.

Wherein, the metal film is made of nickel, silver or a combination thereof.

### BRIEF DESCRIPTION OF THE DRAWINGS

The patent or application file contains at least one color drawing. Copies of this patent or patent application publication with color drawings will be provided by the USPTO upon request and payment of the necessary fee.

FIG. 1 is a schematic diagram of an electrode of a lithium battery after rolling and extruding according to the present invention.

FIG. 2 is a tension test result diagram of an electrode of a lithium battery according to present invention; and

FIG. 3 is a phase diagram for an electrode of a lithium battery with silvering and without silvering.

### DETAILED DESCRIPTION OF THE PREFERRED EMBODIMENT

Advantages and features of the present invention and the method for reaching will be referred to exemplary embodiments and the drawings in more detail to understand more easily. However, the present invention may be implemented in different forms and should not be interpreted limited to the embodiments described here. On the contrary, for the person skilled in the art, the embodiments provided here will help the present disclosure be clearer and more complete and fully describe the scope of the present invention. The present invention will only define the claims appended in the present invention. In the figures, the component or the size and relative sizes for the elements are for illustrating clearly and they are expressed in exaggerated way. Throughout this specification, the same element symbols refer to the same elements. As used herein, the term “and/or” includes combinations of any and one or multiple of all associated listed.

Unless otherwise defined, all terms used herein (including technological and scientific terms) have the same meaning as be understood by the person skilled in the art. It should be understood that, for example, the terms used generally as defined in the dictionary should be understood as consistent meaning in the relative field, and unless the terms obviously defined herein, it shall not be idealized overly or to be understood overly formal.

The following will describe exemplary embodiments in more detail with drawings. However, these embodiments may be included in different forms and should not be explained to limit the scope of the present invention. These embodiments will make the disclosure of the present invention be complete and clear. The person skilled in the art will understand the scope of the present invention through these embodiments.

The object of the present invention is to provide a method for manufacturing an electrode of a lithium battery. In this invention, it will use a different manufacturing method to reach different effects not obtained in the conventional method. For example, it can improve one direction convergence of current in the conventional art to become an electric conduction way with a three-dimensional direction, reducing the problem of decreasing conductivity because of the thermal effect, reducing the problem of oxidation and quality change of the electrode, solving the problem of welding character and rate of decline, and enhancing electrical property.

Thus, the present invention provides a method for manufacturing the electrode of the lithium battery, which comprises the following the steps: (a) providing a substrate; (b) coating a paste on a portion of the substrate; (c) plating a metal film onto the paste or the substrate; (d) disposing a welding point on an end of the substrate.

Wherein, between the step (b) and the step (c), it may further include a step for rolling and extruding the paste. In the step (c), the metal film can be plated onto the paste or the substrate through vapor deposition, electroplating or reduction plating.

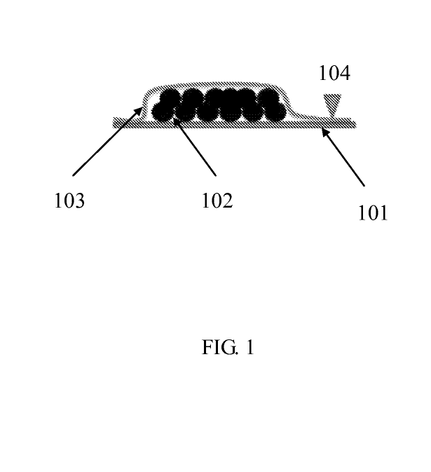

Furthermore, with reference to FIG. 1, the present invention further provides an electrode of a lithium battery, wherein it comprises: a substrate 101; a paste 102 located on a portion of the substrate; a metal film 103 covered on the paste 102 or the substrate 101, wherein, a welding point 104 is disposed at an end of the substrate 101.

Furthermore, the substrate may include copper, aluminum, nickel, manganese, cobalt or combinations thereof; the paste may include a lithium compound, an electric conduction agent, an adhesive or combinations thereof; the lithium compound may include cobalt oxide, lithium nickel oxide, lithium manganese oxide, lithium iron phosphate, lithium nickel cobalt oxide, lithium nickel manganese cobalt lithium or combinations thereof. The electric conduction agent may include ordinary carbon black, superconducting carbon black, colloidal graphite or combinations thereof The adhesive may be a PVDF adhesive. The paste may include graphite, an adhesive, an anti-precipitation agent, isopropyl alcohol, water, or combinations thereof The adhesive may be a styrene-butadiene rubber (SBR) adhesive. The anti-precipitation agent may be a carboxymethyl cellulose (CMC) anti-precipitation agent. The metal film may be made of nickel, silver or combination thereof.

It should be noted that the electrode of lithium battery and the manufacturing method for the same according to the present invention mainly differ from the conventional method in the manufacturing process. The remaining materials use conventional materials or raw materials. A brief description is as follows:

I. The formation of the electrodes: divided into a positive electrode and a negative electrode.

1. The formation of the positive electrode:

(a) Lithium compound: cobalt oxide, lithium nickel oxide, lithium manganese oxide, lithium iron phosphate, lithium nickel cobalt oxide, lithium nickel manganese cobalt lithium or combinations thereof; which function as active materials for the positive electrode, and lithium ion source for increasing lithium source of the lithium battery.

(b) Electric conduction agent: ordinary carbon black, superconducting carbon black, colloidal graphite or combinations thereof for improving the conductivity of the positive electrode, compensating the conductivity of the active material for the positive electrode (increasing the liquid absorption amount of the electrolyte of the positive electrode, increasing reaction interface, reducing polarization).

(c) PVDF adhesive: adhering lithium cobalt oxide, the electric conduction agent and an aluminum foil or an aluminum mesh together.

(d) Positive lead: made of an aluminum foil or an aluminum tape.

2. The formation of the negative electrode:

(a) Graphite: the active material for the negative electrode, the main material for the reaction of the negative electrode; mainly divided into two categories of natural graphite and artificial graphite.

(b) Electric conduction agent: increasing the conductivity of the negative electrode, compensating the conductivity of the active material of the negative electrode (improving the reaction depth and efficiency; preventing the generation of crystal dendrite; using the suction capacity of the electric conduction material to increase the reaction interface to minimize polarization).

(c) Additive: reducing irreversible reaction to improve adhesion force; improving the viscosity of the paste and preventing the precipitate of the paste (add it or not base on the distribution of the particle size of the graphite).

(d) Water-based adhesive: adhering together the graphite, the electric conduction agent, the additive, and a copper foil or a copper mesh.

(e) Negative lead: made of a copper foil or a nickel tape.

II. Material mixing principle:

Material mixing principle for the positive electrode:

(a) Physical and chemical properties of raw materials:

i. Lithium compound: non-polar substance, irregular shape, particle diameter for D50 is usually 6-8 μm, water content ≦0.2%, usually alkaline, PH value about 8-11.

ii. Electric conduction agent: non-polar substance, grape- chain-shape substance, water content 3%-6%, oil absorption value about 300, the particle diameter is generally 2-5 μm; mainly ordinary carbon black, superconductive carbon black, colloidal graphite, etc., in high-volume applications, generally choose a combination of the superconducting carbon black and the colloidal graphite; usually neutral.

iii. PVDF adhesive: non-polar substance; chain-like substance; the molecular weight ranging from 300,000 to 3,000,000; after absorbing water, the molecular weight and viscosity are decreased.

iv. N-methyl-pyrrolidone (NMP) solution: weakly polar liquid for dissolution/swelling PVDF, and also used to dilute the paste.

(b) Pretreatment of raw materials:

i. Lithium compound: dehydration; generally use 120° C. at atmospheric pressure to bake about 2 hours.

ii. Electric conduction agent: dehydration; general use 200° C. at atmospheric pressure to bake about 2 hours.

iii. PVDF adhesive: dehydration; generally use 120° C.-140° C. at atmospheric pressure to bake about 2 hours; the baking temperature depending on the molecular weight.

iv. NMP: dehydration; using dry molecular to dehydrate or using special picking equipment; using it directly.

(c) Mixing of the raw materials:

i. Dissolving of the adhesive (at standard concentration) and heat treatment.

ii. Ball milling of the lithium cobalt oxide and the electric conduction agent: initially mix the powder; the lithium cobalt oxide and the electric conduction agent are adhered together to improve the agglomeration effect and the conductivity; after mixing as the paste, they will not distribute in the adhesive alone, ball milling time generally about 2 hours; in order to avoid mixing of impurities, typically using agate balls as milling media.

(d) Dispersion and wetting of dry powder:

i. Principle: Solid powder is placed is in the air. With the passage of time, the powder will adsorb the air on the surface of the solid powder. After the liquid adhesive is added, the liquid and the air begin to compete with the surface of the solid power. If the adsorption force is stronger for the air, the liquid does not wet the solid powder; if the adsorption force is stronger for the liquid, the liquid can wet the solid powder to discharge the air. Because all the materials on the positive electrode can be wetted by the adhesive solution, the powder on the positive electrode is relatively easy to disperse.

ii. The effect of the dispersion method for dispersion:

Method A: Standing method (long time spending; bed in effect, but does not damage the original structures of the materials);

Method B: Stirring method; rotation or rotation plus revolution (short time spending, good in effect, but may be damage to the structure of individual material itself).

(e) Dilution; the paste is adjusted to the appropriate concentration for coating easily.

2. Material mixing principle for the negative electrode: (roughly the same with the positive principle)

(a) Physical and chemical properties of the raw materials.

i. Graphite: non-polar substance; easily to be polluted by a non-polar substance, easily to disperse in a non-polar substance; not easy to absorb water and disperse in water. The populated graphite is easy to re-agglomerate after dispersing in water. Average particle diameter for D50 is about 20 μm. The particle shape is diversity and irregular, and is mainly spherical, flake, or fibrous.

ii. Styrene-butadiene rubber (SBR) adhesive: small molecule linear chain emulsion, very easy to dissolve in water and a polar solvent.

iii. Carboxymethyl cellulose (CMC) anti-precipitation agent: polymer, easy to dissolve in water or a polar solvent.

iv. Isopropyl alcohol: weakly polar substance; can decrease the polarity of the solution of the adhesive after adding it; increasing the compatibility of graphite and the solution of the adhesive; having strong anti-foaming effect; easy to catalyze the adhesive to become mesh cross-linked, to improve adhesive strength.

v. Deionized water (or distilled water): a diluent, add by consideration, change the fluidity of the paste.

(b) Pretreatment of the raw materials:

i. Graphite: mixing first to make the raw material homogeneous in order to improve consistency; baking under atmospheric pressure at 300° C.˜400° C. in order to remove the oily substances on the surface to improve the compatibility with aqueous adhesive, round the edges of the surface of the graphite (some materials are not allowed to bake or the performance will reduce).

ii. Styrene-butadiene rubber (SBR) adhesive: dilute properly to improve the dispersion ability.

(c) Mixing, wetting and dispersion:

i. Graphite and adhesive solution have different polarities, and they are difficult to disperse.

ii. It can use alcohol aqueous solution to wet the graphite initially, and then mixed it with the adhesive solution.

iii. It should appropriately reduce the stirring concentration to increase dispersion ability.

iv. The dispersion process is a process of reducing the distance between the polar substance and the non-polar substance and increasing potential or surface energy, so that the dispersion process is an endothermic reaction. In stirring, the overall temperature is decreased. If condition is allowed, it should rise the stirring temperature appropriately to make the endothermic reaction become easier, improve mobility and reduce dispersion difficult at the same time.

v. If it adds a vacuum degassing process to discharge the air, it will facilitate solid-liquid adsorption, and the effect is better.

(d) Dilution: Adjusting the paste to an appropriate concentration for coating easily.

The above materials are the main materials used by the present invention, and they are substantially the same with the conventional materials. However, the novelty of the present invention is that coating the paste first, and after a rolling and extruding process, coating a conductive metal film such as a silver film or a nickel film. The foregoing way can obtain the effect which does not have before. For example, solving the problem of the aging of the battery electrodes, improving welding problem of the battery electrodes, improving current flowing only at one direction (that is, change to a three-dimensional current channel), reducing the problem of decreasing conductivity because of the thermal effect (that is, reducing the internal resistance), enhancing electrical property, and reducing decline rate of cycling charging and discharging.

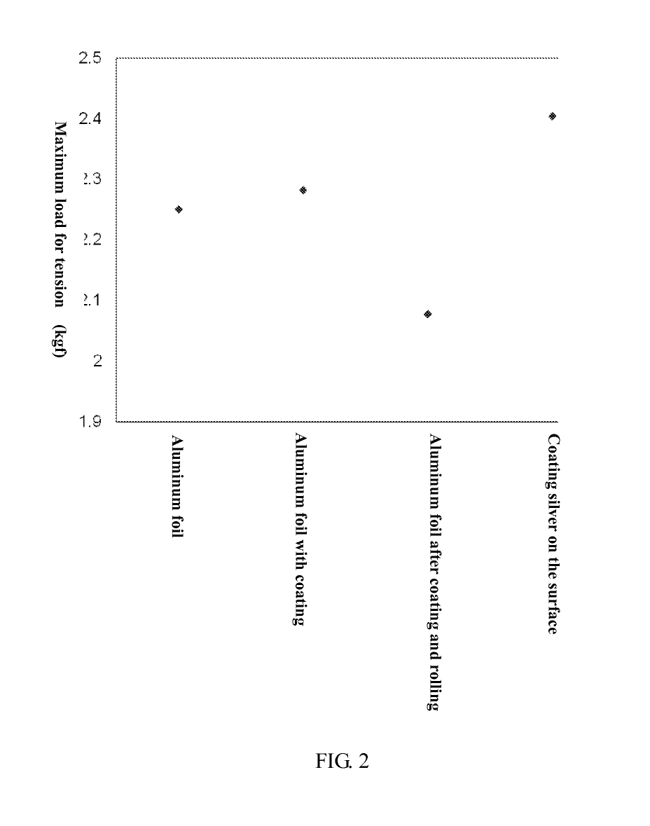

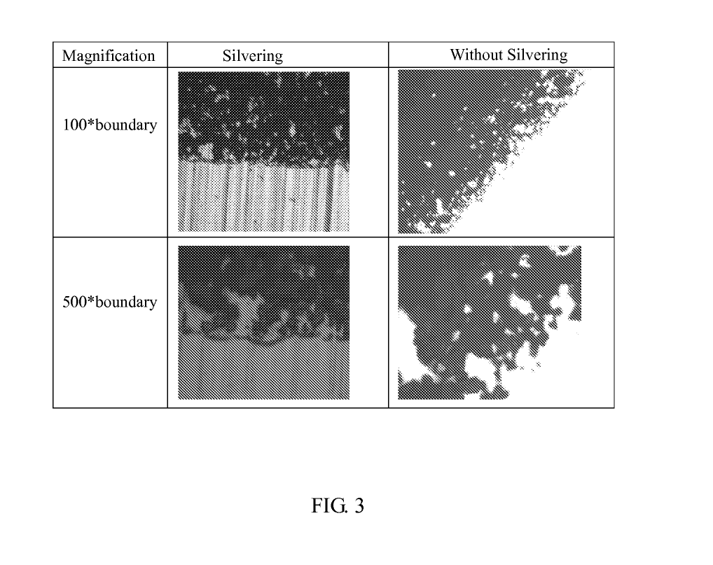

Therefore, the following actually test the lithium battery of the present invention, and the test result is shown in FIG. 2 and FIG. 3.

### Embodiment 1

With reference to FIG. 2, a tension force test result diagram of the electrode of the lithium battery according to the present invention. The vertical axis indicates the maximum load for tension (Kgf) and the horizontal axis indicates the electrodes in different states, which are an aluminum foil, an aluminum foil with coating (i.e.: the aluminum foil coated with the paste), an aluminum foil after coating and rolling (i.e.: the aluminum foil after coating with the paste and after rolling and extruding), and coating silver on the surface (i.e.: an aluminum foil after coating with the paste, after rolling and extruding, and after coating silver on the surface).

The experimental conditions are in a vacuum degree of 4×10-5 torr, a deposition thickness of 235 nm, a deposition rate of 8.4 nm/s. As shown in FIG. 2, the maximum load for tension for the electrode plate of the aluminum foil is 2.2˜2.3 kgf; the status of the aluminum foil with coating is similar to the aluminum foil; Because the internal structure of the aluminum foil after coating and rolling is changed, the maximum load for tension is significantly decreased; On the contrary, for the electrode plate after coating silver on the surface, the paste is covered by the silver, so that the maximum load for tension is increased significantly to 2.4˜2.5 kgf. It can be known, the method for manufacturing the electrode of the lithium battery the present invention can significantly enhance the physical property of tension force

### Embodiment 2

In addition, with reference to FIG. 3, it is a phase diagram for an electrode of a lithium battery with silvering and without silvering. From low magnification diagram (100×), the uniformity after coating with a silver film is better. Furthermore, from high magnification diagram (500×), comparing with the electrode without coating the silver film, the combination degree with the metal is increase at the boundary.

It should be noted that, the silver film in this embodiment is only used for an example, not intended to limit the scope of the present invention. The other conductive metal film such as a Ni film can also achieve the same effect.

The present invention refer to several embodiments for further describing a method for manufacturing an electrode of a lithium battery and its advantages and effects, but it is not intended to limit the scope of the invention.

In summary, the present invention has the following advantages:

1. Improving the one direction convergence of conventional current to become an electric conduction mode with three-dimension direction;

2. Reducing the problem of decreasing the conductivity because of the thermal effect and protecting the electrode plate from oxidation and quality change;

3. Solving welding character and the decline rate; and

4. Enhancing electrical property.

The above embodiments of the present invention are not used to limit the claims of this invention. Any use of the content in the specification or in the drawings of the present invention which produces equivalent structures or equivalent processes, or directly or indirectly used in other related technical fields is still covered by the claims in the present invention.

What is claimed is:

1. A method for manufacturing an electrode of a lithium battery, comprising steps of:
(a) providing a substrate;
(b) coating a paste on a portion of the substrate;
(c) plating a metal film onto the paste or the substrate; and
(d) disposing a welding point at an end of the substrate.

2. The method according to claim 1, wherein, further including a step for rolling and extruding the paste between the step (b) and the step (c).

3. The method according to claim 1, wherein, in the step (c), the metal film is plated onto the paste or the substrate through vapor deposition, electroplating or reduction plating.

4. The method according to claim 1, wherein, the substrate includes copper, aluminum, nickel, manganese, cobalt or combinations thereof

5. The method according to claim 1, wherein, the paste includes a lithium compound, an electric conduction agent, an adhesive or combinations thereof.

6. The method according to claim 5, wherein, the lithium compound includes cobalt oxide, lithium nickel oxide, lithium manganese oxide, lithium iron phosphate, lithium nickel cobalt oxide, lithium nickel manganese cobalt lithium or combinations thereof.

7. The method according to claim 5, wherein, the electric conduction agent includes ordinary carbon black, superconducting carbon black, colloidal graphite or combinations thereof.

8. The method according to claim 5, wherein, the adhesive is a PVDF adhesive.

9. The method according to claim 1, wherein, the paste includes a graphite, an adhesive, an anti-precipitation agent, isopropyl alcohol, water, or combinations thereof.

10. The method according to claim 9, wherein, the adhesive is a styrene-butadiene rubber (SBR) adhesive.

11. The method according to claim 9, wherein, the anti-precipitation agent is a carboxymethyl cellulose (CMC) anti-precipitation agent.

12. The method according to claim 1, wherein, the metal film is made of nickel, silver or a combination thereof.
